(19) United States
(12) Patent Application Publication
(10) Pub. No.: US 2021/0207328 A1
(43) Pub. Date: Jul. 8, 2021

(54) KITCHEN PAPER ROLL AND KITCHEN PAPER

(71) Applicant: DAIO PAPER CORPORATION, Ehime (JP)

(72) Inventor: Hirohiko KATO, Shizuoka (JP)

(21) Appl. No.: 17/056,539

(22) PCT Filed: Jun. 3, 2019
(86) PCT No.: PCT/JP2019/022025

§ 371 Date: Nov. 18, 2020

(30) Foreign Application Priority Data
Jun. 4, 2018 (JP) 2018-107295

(51) Int. Cl. D21H 27/40; A47K 10/16; B31F 1/07; D21H 27/00

(52) U.S. Cl. CPC D21H 27/40; A47K 10/16; B31F 2201/0715; D21H 27/002; B31F 2201/0764; B31F 1/07

(57) ABSTRACT

A kitchen paper roll includes a kitchen paper that is formed by joining two sheets in a nested manner and is wound to form the kitchen paper roll. Each of the sheets includes an embossed region. The density of embossed protrusions on each of the sheets is greater than or equal to 0.075/mm² and less than or equal to 0.2/mm², the winding density of the kitchen paper is greater than or equal to 0.12 m/cm² and less than or equal to 0.27 m/cm², and the ratio of a minimum embossment area to a maximum embossment area in the kitchen paper is greater than or equal to 0.51.

### TECHNICAL FIELD

The present invention relates to a kitchen paper roll and kitchen paper.

### BACKGROUND ART

There is known kitchen paper used in the form of a kitchen paper roll formed by winding the kitchen paper into a roll. In these years, due to changes in consumers' lifestyles, daily necessities with high storability and stockability tend to be preferred, and various long-type kitchen paper roll products with an increased kitchen paper winding length are available.

For example, Japanese Unexamined Patent Application Publication No. 2017-115263 (Patent Document 1) discloses a paper towel roll formed by winding a paper towel in which two single-layer sheets having a basis weight greater than or equal to 19.0 g/m² and less than or equal to 25.0 g/m² are stacked. In the paper towel roll, the paper towel is wound at a winding density greater than or equal to 0.50 m/cm² and less than or equal to 0.80 m/cm², a winding hardness less than 10 mm, and a winding length greater than or equal to 20 m and less than or equal to 40 m.

### RELATED-ART DOCUMENT

### Patent Document

[Patent Document 1] Japanese Unexamined Patent Publication No. 2017-115263

### DISCLOSURE OF INVENTION

### Problems to be Solved by the Invention

With the related-art kitchen paper roll, the winding diameter increases as the winding length of the kitchen paper increases. To increase the winding length of the kitchen paper without increasing the winding diameter, it is necessary to increase the winding density of the kitchen paper or decrease the bulk of the kitchen paper. However, as the winding density of the kitchen paper increases, the kitchen paper becomes more likely to be flattened in the thickness direction. Also, when the bulk of the kitchen paper is low, it is difficult to reliably form a space in the kitchen paper. Accordingly, when the winding length of the kitchen paper increases, the capacity of the kitchen paper for absorbing water or oil decreases, and the kitchen paper becomes hard and difficult to handle.

One object of the present invention is to provide a kitchen paper roll configured such that the absorbency and softness of kitchen paper are maintained even when the winding length of the kitchen paper is increased.

### Means for Solving the Problems

In an aspect of the present invention, there is provided a kitchen paper roll including a kitchen paper that is formed by joining two sheets in a nested manner and is wound to form the kitchen paper roll. Each of the sheets includes an embossed region. The density of embossed protrusions on each of the sheets is greater than or equal to 0.075/mm² and less than or equal to 0.2/mm², the winding density of the kitchen paper is greater than or equal to 0.12 m/cm² and less than or equal to 0.27 m/cm², and the ratio of a minimum embossment area to a maximum embossment area in the kitchen paper is greater than or equal to 0.51.

### Advantageous Effect of the Invention

An aspect of the present invention makes it possible to provide a kitchen paper roll configured such that the absorbency and softness of kitchen paper are maintained even when the winding length of the kitchen paper is increased.

### BRIEF DESCRIPTION OF THE DRAWINGS

FIG. 1 is a drawing illustrating a kitchen paper roll according to an embodiment of the present invention;

FIG. 2 is an enlarged view of a portion surrounded by a line 1A in FIG. 1;

FIG. 3 is an enlarged view of a portion surrounded by a line 2A in FIG. 2;

FIG. 4 is a cross-sectional view taken along line 3A-3A of FIG. 3;

FIG. 5 is a drawing illustrating a measurement method in an oil absorption test;

FIG. 6 is a drawing illustrating a related-art kitchen paper roll (kitchen paper with a tip-to-tip structure);

FIG. 7 (A) is an enlarged view of a portion surrounded by a line 6A in FIG. 6, and FIG. 7 (B) is an enlarged view of a portion surrounded by a line 6B in FIG. 6;

FIG. 8 (A) is a cross-sectional view taken along line 7A-7A of FIG. 7 (A), and FIG. 8 (B) is a cross-sectional view taken along line 7B-7B of FIG. 7 (B);

FIG. 9 is a drawing illustrating a related-art kitchen paper roll (kitchen paper with a nested structure);

FIG. 10 (A) is an enlarged view of a portion surrounded by a line 9A in FIG. 9, and FIG. 10 (B) is an enlarged view of a portion surrounded by a line 9B in FIG. 9; and

FIG. 11 (A) is a cross-sectional view taken along line 10A-10A of FIG. 10 (A), and FIG. 11 (B) is a cross-sectional view taken along line 10B-10B of FIG. 10 (B).

### DESCRIPTION OF EMBODIMENTS

Embodiments of the present invention are described below in detail with reference to the accompanying drawings. In the present application, to facilitate the understanding, the scale of components in the drawings may be different from the actual scale. Also, in the descriptions below, the same reference number is assigned to the same component throughout the drawings, and the repeated descriptions of the same component may be omitted.

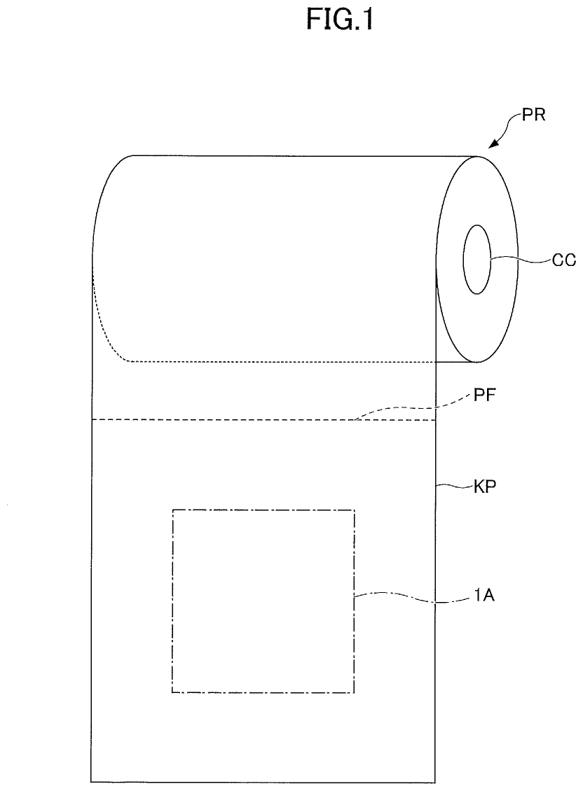

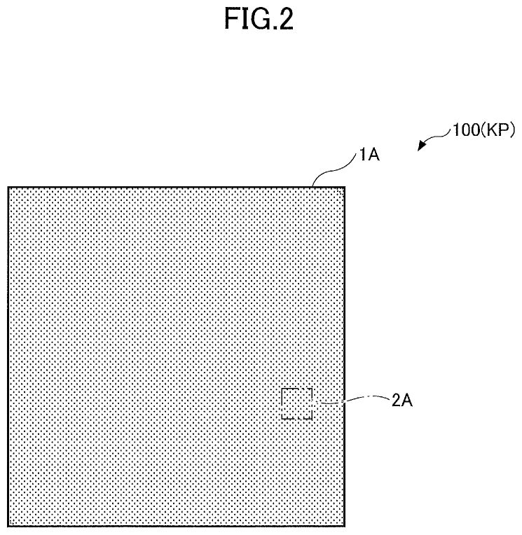

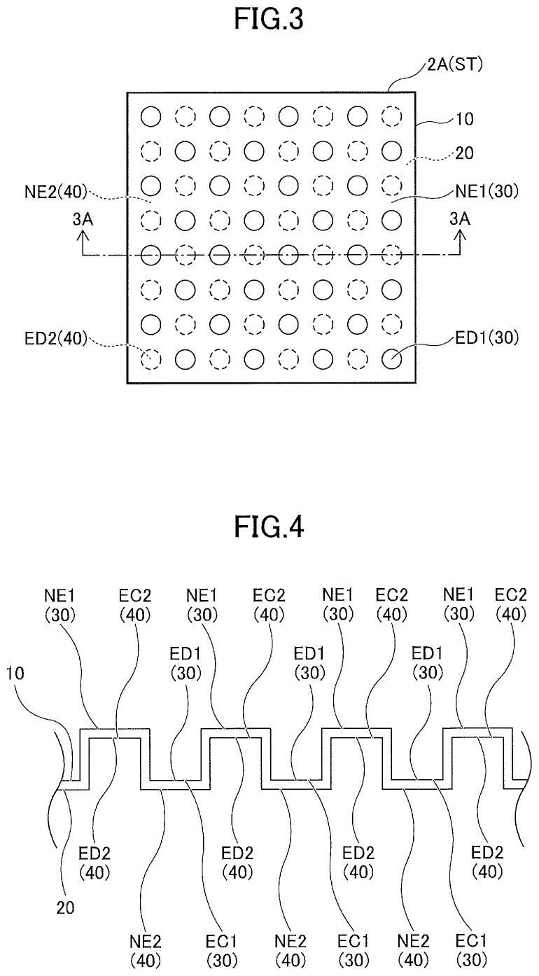

FIG. 1 is a drawing illustrating a kitchen paper roll PR according to an embodiment of the present invention. FIG. 2 is an enlarged view of a portion surrounded by a line 1A in FIG. 1. FIG. 3 is an enlarged view of a portion surrounded by a line 2A in FIG. 2. FIG. 4 is a cross-sectional view taken along line 3A-3A in FIG. 3.

The kitchen paper roll PR is formed by winding kitchen paper KP. Specifically, as illustrated in FIG. 1, the kitchen paper roll PR is formed by winding the kitchen paper KP with a band or elongated shape around a cylindrical core CC in the circumferential direction. In the kitchen paper KP, perforation lines PF for separation are arranged at predetermined intervals.

The kitchen paper KP includes two sheets 10 and 20. The material of the sheets 10 and 20 is, for example, but is not limited to, crepe paper used for the kitchen paper KP. Fine wrinkles are formed on the surface of crepe paper by bringing a so-called doctor blade into contact with the surface at the exit of a dryer of a paper machine in a paper making process.

For the crepe paper forming the sheets 10 and 20, base paper mainly made of pulp is used. As a non-limiting example of the pulp composition, the proportion of pulp is greater than or equal to 50 mass %, preferably greater than or equal to 90 mass %, and more preferably 100 mass %.

The pulp composition of the crepe paper is not limited to any specific composition. For example, softwood pulp such as needle bleached kraft pulp (NBKP) or needle unbleached kraft pulp (NUKP) and hardwood pulp such as leaf bleached kraft pulp (LBKP) or leaf unbleached kraft pulp (LUKP) may be mixed at an appropriate ratio. Particularly, in the pulp composition, the proportion of softwood pulp is preferably greater than the proportion of hardwood pulp. The ratio of softwood pulp to hardwood pulp is preferably between 50:50 and 80:20.

As a non-limiting example, the basis weight of crepe paper may be represented by a basis weight (or paper density) measured according to JIS P 8124 (1998). When sanitary tissue paper is kitchen paper 100 (KP), the basis weight of each ply of crepe paper constituting the sanitary tissue paper is preferably greater than or equal to 14 g/m² and less than or equal to 50 g/m², more preferably greater than or equal to 15 g/m² and less than or equal to 35 g/m², and further preferably greater than or equal to 16 g/m² and less than or equal to 24 g/m².

As a non-limiting example, the thickness of crepe paper may be measured under an environment defined in JIS P 8111 (1998). When sanitary tissue paper is kitchen paper 100 (KP), the thickness of each ply of crepe paper is preferably greater than or equal to 150 μm and less than or equal to 500 μm and more preferably greater than or equal to 200 μm and less than or equal to 330 μm.

After sufficiently adjusting the humidity of a specimen under conditions defined in JIS P 8111 (1998), the thickness of two plies of the specimen is measured by using a dial thickness gauge (thickness measuring instrument) “PEACOCK model G” (manufactured by OZAKI MFG. CO., LTD) under the same conditions. Specifically, after confirming that there is no dust or dirt between a plunger and a measurement table, the plunger is lowered onto the measurement table, and the scale of the dial thickness gauge is moved to adjust the zero point. The plunger is lifted to place the specimen on the measurement table, the plunger is slowly lowered, and then the gauge is read. In this process, the plunger is just placed on the specimen. The plunger has a circular end part that is made of a metal and has a diameter of 10 mm. The plunger is placed on the specimen such that a flat surface of the circular end part perpendicularly contacts the paper surface. The load applied when measuring the thickness is about 70 gf. An average of ten measurements is used as the measurement of the thickness.

An embossed region 30 of the sheet 10 is a region in the sheet 10 on which an embossing process is performed. Specifically, in the embossed region 30, multiple embossed protrusions EC1 and multiple embossed recesses ED1 corresponding to the embossed protrusions EC1 are formed on the front and back sides of the sheet 10 (see FIG. 3 and FIG. 4). Also, multiple non-embossed protrusions NE1 are formed in the embossed region 30. Each non-embossed protrusion NE1 indicates a portion that is surrounded by multiple embossed protrusions EC1 and where no protrusion is formed (see FIG. 3 and FIG. 4).

An embossed region 40 of the sheet 20 is a region in the sheet 20 on which an embossing process is performed. Specifically, in the embossed region 40, multiple embossed protrusions EC2 and multiple embossed recesses ED2 corresponding to the embossed protrusions EC2 are formed on the front and back sides of the sheet 20 (see FIG. 3 and FIG. 4). Also, multiple non-embossed protrusions NE2 are formed in the embossed region 40. Each non-embossed protrusion NE2 indicates a portion that is surrounded by multiple embossed protrusions EC2 and where no protrusion is formed (see FIG. 3 and FIG. 4).

The embossed protrusions EC1 are formed on one side of the sheet 10 by pressing a protrusion embossing roller (not shown) against the sheet 10 according to a known steel rubber embossing method. In this process, the embossed recesses ED1 are formed on the other side of the sheet 10 at positions corresponding to the embossed protrusions EC1. Also, the non-embossed protrusions NE1, each of which is surrounded by embossed protrusions EC1, are formed on the sheet 10 at the same time (see FIG. 3 and FIG. 4).

The embossed protrusions EC2 are formed on one side of the sheet 20 by pressing a protrusion embossing roller (not shown) against the sheet 20 according to a known steel rubber embossing method. In this process, the embossed recesses ED2 are formed on the other side of the sheet 20 at positions corresponding to the embossed protrusions EC2. Also, the non-embossed protrusions NE2, each of which is surrounded by embossed protrusions EC2, are formed on the sheet 20 at the same time (see FIG. 3 and FIG. 4).

As a non-limiting example, the top part of the embossed protrusion EC1 (or the opening of the embossed recess ED1) may have a circular shape, a triangular shape, a rectangular shape, or an oblong shape in plan view. In terms of increasing the strength of the embossed protrusion EC1, the top part of the embossed protrusion EC1 preferably has a circular shape (see FIG. 3). Also, the lateral side of the embossed protrusion EC1 (or the embossed recess ED1) may be tapered (not shown) from the bottom toward the opening of the embossed recess ED1.

As a non-limiting example, the top part of the embossed protrusion EC2 (or the opening of the embossed recess ED2) may have a circular shape, a triangular shape, a rectangular shape, or an oblong shape in plan view. In terms of increasing the strength of the embossed protrusion EC2, the top part of the embossed protrusion EC2 preferably has a circular shape (see FIG. 3). Also, the lateral side of the embossed protrusion EC2 (or the embossed recess ED2) may be tapered (not shown) from the bottom toward the opening of the embossed recess ED2.

As a non-limiting example, the size of each embossed protrusion EC1 on the sheet 10 is preferably greater than or equal to 1 mm and less than or equal to 1.6 mm, more preferably greater than or equal to 1.2 mm and less than or equal to 1.4 mm, and further preferably greater than or equal to 1.3 mm and less than or equal to 1.38 mm. As a non-limiting example, the size of each embossed protrusion EC2 on the sheet 20 is preferably greater than or equal to 1 mm and less than or equal to 1.6 mm, more preferably greater than or equal to 1.2 mm and less than or equal to 1.4 mm, and further preferably greater than or equal to 1.3 mm and less than or equal to 1.38 mm. Here, the size of each embossed protrusion indicates a diameter of a circle when the embossed protrusion has a circular shape, a length of each side when the embossed protrusion has a rectangular or triangular shape, or a major or minor diameter when the embossed protrusion has an oblong shape.

As a non-limiting example, the unit area of each embossed protrusion EC1 on the sheet 10 is preferably greater than or equal to 0.5 mm² and less than or equal to 2 mm², more preferably greater than or equal to 1 mm² and less than or equal to 1.7 mm², and further preferably greater than or equal to 1.3 mm² and less than or equal to 1.6 mm². As a non-limiting example, the size of each embossed protrusion EC2 on the sheet 20 is preferably greater than or equal to 0.5 mm² and less than or equal to 2 mm², more preferably greater than or equal to 1 mm² and less than or equal to 1.7 mm², and further preferably greater than or equal to 1.3 mm² and less than or equal to 1.6 mm². Here, the unit area of each embossed protrusion may be represented by a diameter of a circle when the embossed protrusion has a circular shape or by an area of the top part of each embossed protrusion when the embossed protrusion has a rectangular or triangular shape.

In the kitchen paper 100 (KR), the sheet 10 including the embossed region 30 and the sheet 20 including the embossed region 40 are disposed to face each other and joined in a nested manner. Specifically, the embossed protrusions EC1 on the sheet 10 are arranged to face the non-embossed protrusions NE2 (portions where the embossed protrusions EC2 are not formed) on the sheet 20. Also, the embossed protrusions EC2 on the sheet 20 are arranged to face the non-embossed protrusions NE1 (portions where the embossed protrusions EC1 are not formed) on the sheet 10 (see FIGS. 1 to 4).

Also, the top parts of the embossed protrusions EC1 on the sheet 10 are bonded to the non-embossed protrusions NE2 on the sheet 20 with an adhesive (not shown). Bonding the top parts of the embossed protrusions EC1 on the sheet 10 to the non-embossed protrusions NE2 on the sheet 20 makes it possible to arrange bonded portions of two sheets 10 and 20 on one crepe paper (the sheet 10) in a balanced manner. This in turn makes it possible to suppress a decrease in absorbency caused by the adhesive.

As the adhesive, any known adhesive for kitchen paper having a laminated structure may be used. Examples of materials of the adhesive include polyvinyl alcohol, starch, modified starch, and carboxymethyl cellulose.

Instead of bonding the top parts of the embossed protrusions EC1 on the sheet 10 to the non-embossed protrusions NE2 on the sheet 20, the top parts of the embossed protrusions EC2 on the sheet 20 may be bonded to the non-embossed protrusions NE1 on the sheet 10. Also, the top parts of the embossed protrusions EC1 on the sheet 10 may be bonded to the non-embossed protrusions NE2 on the sheet 20, and the top parts of the embossed protrusions EC2 on the sheet 20 may also be bonded to the non-embossed protrusions NE1 on the sheet 10.

Any type of cylindrical core may be used as the cylindrical core CC as long as the kitchen paper KP can be wound around the cylindrical core. Also, the cylindrical core CC may be a structure without a winding core (coreless structure). The material of the cylindrical core CC may be, for example, but is not limited to, paper or resin. A cylindrical cardboard core (which is also referred to as a paper core) is preferably used when the kitchen paper roll PR is formed by winding the kitchen paper KP around the core.

As a non-limiting example, the outer diameter of the cylindrical core CC may be the same as the outer diameter of a paper core used for a known kitchen paper roll. Specifically, the outer diameter of the cylindrical core CC is greater than or equal to 37 mm and less than or equal to 43 mm.

Although not limited to any specific length, the winding length of the kitchen paper KP (100) of the kitchen paper roll PR is preferably set at a longest possible value at which the absorbency and the softness of the kitchen paper KP (100) can be maintained. From this point of view, the winding length of the kitchen paper KP (100) is preferably greater than or equal to 5 m and less than or equal to 40 m, more preferably greater than or equal to 8 m and less than or equal to 30 m, and further preferably greater than or equal to 10 m and less than or equal to 25 m. Here, the winding length indicates the length of the kitchen paper that is wound around the cylindrical core to form the kitchen paper roll.

Although not limited to any specific value, from the viewpoint of not reducing the versatility of the kitchen paper roll, the winding diameter of the kitchen paper roll PR is preferably greater than or equal to 95 mm and less than or equal to 140 mm, more preferably greater than or equal to 100 mm and less than or equal to 120 mm, and further preferably greater than or equal to 104 mm and less than or equal to 119 mm. Here, the winding diameter indicates the outer diameter in the radial direction of the kitchen paper roll including the outer diameter of the cylindrical core.

In the kitchen paper roll PR according to the present embodiment, the density of the embossed protrusions EC1 on the sheet 10 constituting the kitchen paper KP is greater than or equal to 0.075/mm² and less than or equal to 0.2/mm², preferably greater than or equal to 0.076/mm² and less than or equal to 0.15/mm², and more preferably greater than or equal to 0.077/mm² and less than or equal to 0.1/mm². The density of the embossed protrusions EC2 on the sheet 20 is greater than or equal to 0.075/mm² and less than or equal to 0.2/mm², preferably greater than or equal to 0.076/mm² and less than or equal to 0.15/mm², and more preferably greater than or equal to 0.076/mm² and less than or equal to 0.1/mm². Here, the density of embossed protrusions indicates the number of embossed protrusions per unit area of the sheet.

In the kitchen paper roll PR of the present embodiment, the winding density of the kitchen paper KP is greater than or equal to 0.12 m/cm² and less than or equal to 0.27 m/cm², preferably greater than or equal to 0.13 m/cm² and less than or equal to 0.26 m/cm², and more preferably greater than or equal to 0.14 m/cm² and less than or equal to 0.25 m/cm². Here, the winding density is a value obtained by dividing the winding length (m) of the kitchen paper KP by the area (cm²) in the radial direction of the kitchen paper roll PR. In the kitchen paper roll PR, setting the winding density of the kitchen paper KP to a value within the described range makes it possible to increase the winding length of the kitchen paper without increasing the winding diameter.

In the kitchen paper roll PR, the ratio of a minimum embossment area to a maximum embossment area (which is hereafter referred to as an “area ratio”) is greater than or equal to 0.51, preferably greater than or equal to 0.515, and more preferably greater than or equal to 0.52.

Here, the minimum embossment area indicates the area of a portion of the kitchen paper KP where the total area of the top parts of the embossed protrusions EC1 and EC2 per unit area (cm²) is smallest. Also, the maximum embossment area indicates the area of a portion of the kitchen paper KP where the total area of the top parts of the embossed protrusions EC1 and EC2 per unit area (cm²) is largest. Further, the ratio of the minimum embossment area to the maximum embossment area indicates the area ratio of the minimum embossment area to the maximum embossment area.

As described above, in the present embodiment, the kitchen paper KP constituting the kitchen paper roll PR is formed by joining two sheets 10 and 20 in a nested manner. In each of the sheets 10 and 20, the density of embossed protrusions is greater than or equal to 0.075/mm² and less than or equal to 0.2/mm². The kitchen paper KP is wound such that the winding density becomes greater than or equal to 0.12 m/cm² and less than or equal to 0.27 m/cm². Also, in the kitchen paper KP, the area ratio of the minimum embossment area to the maximum embossment area is greater than or equal to 0.51.

The kitchen paper KP wound to form the kitchen paper roll PR is not readily flattened in the thickness direction, and the space inside of the kitchen paper KP can be maintained. Accordingly, with the present embodiment, the kitchen paper KP is not readily flattened in the thickness direction even if the winding density of the kitchen paper KP is high. The present embodiment also makes it possible to increase the winding length of the kitchen paper KP while maintaining the bulk of the kitchen paper KP. Thus, the present embodiment makes it possible to provide the kitchen paper roll PR configured such that the absorbency and the softness of the kitchen paper KP can be maintained even if the winding length of the kitchen paper KP is increased.

In the kitchen paper roll PR of the present embodiment, the sheet 10 includes only the embossed region 30, and the sheet 20 includes only the embossed region 40. That is, in the kitchen paper roll PR of the present embodiment, neither one of 10 and 20 constituting the kitchen paper KP includes a non-embossed region. Here, the non-embossed region is a region in the sheet 10/20 on which the embossing process is not performed. In other words, a non-embossed region is a region in which none of the embossed protrusions EC1 and EC2 and the non-embossed protrusions NE and NE2 is formed.

In the present embodiment, because each of the sheets 10 and 20 constituting the kitchen paper KP does not include a non-embossed region, a non-embossed space (which is hereafter referred to as a non-embossed space or a line) where non-embossed regions face each other is not formed in the kitchen paper KP.

Such non-embossed spaces enable kitchen paper to retain water or oil absorbed in the kitchen paper or disperse water or oil in the kitchen paper. Therefore, in the related-art kitchen paper, non-embossed spaces are formed to increase the absorbency of the kitchen paper.

On the other hand, in the kitchen paper roll PR formed by winding the kitchen paper KP according to the present embodiment, if non-embossed spaces exist in the kitchen paper KP, the kitchen paper KP is readily flattened, and the absorbency of the kitchen paper KP decreases. In the present embodiment, because such non-embossed spaces do not exist in the kitchen paper KP, the absorbency of the kitchen paper KP can be maintained even in the state of the kitchen paper roll PR.

Also, if non-embossed spaces exist in the kitchen paper, the kitchen paper tends to become hard. As a result, it becomes difficult to fold the kitchen paper and to wipe curved surfaces and gaps with the kitchen paper. On the other hand, in the present embodiment, because such non-embossed spaces do not exist in the kitchen paper KP, the kitchen paper KP constituting the kitchen paper roll PR becomes soft and can be easily folded, and curved surfaces and gaps can be easily wiped withe the kitchen paper KP.

Also, in the present embodiment, the kitchen paper roll PR formed of the kitchen paper KP including no non-embossed space is obtained by configuring the kitchen paper KP such that the ratio of the minimum embossment area to the maximum embossment area becomes greater than or equal to 0.51 in the kitchen paper roll PR. The present embodiment makes it possible to maintain or improve the absorbency of the kitchen paper KP and obtain softer kitchen paper without forming non-embossed regions in each of the sheets 10 and 20 constituting the kitchen paper KP.

As a non-limiting example, in the kitchen paper roll PR of the present embodiment, the area percentage of the embossed protrusions EC1 in the embossed region 30 of the sheet 10 is preferably greater than or equal to 8% and less than or equal to 14%, more preferably greater than or equal to 9% and less than or equal to 13%, and further preferably greater than or equal to 9.5% and less than or equal to 12%. Also, as a non-limiting example, the area percentage of the embossed protrusions EC2 in the embossed region 40 of the sheet 20 is preferably greater than or equal to 8% and less than or equal to 14%, more preferably greater than or equal to 9% and less than or equal to 13%, and further preferably greater than or equal to 9.5% and less than or equal to 12%.

Here, the area percentage of the embossed protrusions EC1 is the percentage of the area of the top parts of the embossed protrusions EC1 in the embossed region 30 in the surface of the sheet 10. Also, the area percentage of embossed protrusions EC2 is the percentage of the area of the top parts of the embossed protrusions EC2 in the embossed region 40 in the surface of the sheet 20.

Setting the area percentages of the embossed protrusions EC1 and EC2 within the above ranges makes it possible to form sufficient spaces in the kitchen paper KP such that the spaces are not readily flattened. Therefore, according to the kitchen paper roll PR of the present embodiment, the absorbency of the kitchen paper KP can be further increased.

The difference between the maximum thickness and the minimum thickness of the kitchen paper KP of the present embodiment is preferably greater than or equal to 0.03 mm and less than or equal to 0.115 mm, more preferably greater than or equal to 0.05 mm and less than or equal to 0.11 mm, and further preferably greater than or equal to 0.06 mm and less than or equal to 0.105 mm.

Here, the maximum thickness is the thickness of a portion of the kitchen paper KP where the thickness is largest. The minimum thickness is the thickness of a portion of the kitchen paper KP where the thickness is smallest. The difference (thickness difference) between the maximum thickness and the minimum thickness is obtained by subtracting the minimum thickness from the maximum thickness.

In the present embodiment, the thickness difference of the kitchen paper KP is set within the above ranges to increase the bulk of the kitchen paper KP while making the kitchen paper KP less likely to be flattened in the thickness direction. Therefore, according to the kitchen paper roll PR of the present embodiment, the absorbency of the kitchen paper KP can be further increased.

According to the kitchen paper roll PR of the present embodiment, the thickness of a stack of five sheets of the kitchen paper KP is preferably greater than or equal to 1.9 mm and less than or equal to 4 mm, more preferably greater than or equal to 2 mm and less than or equal to 3.8 mm, and further preferably greater than or equal to 2.1 mm and less than or equal to 3.5 mm. Here, the thickness of the stack of five sheets of the kitchen paper KP is the thickness (mm) in the stacking direction of five sheets of the kitchen paper KP obtained from the kitchen paper roll PR and indicates the bulk of the kitchen paper KP. The thickness of a stack of five sheets of kitchen paper may be used as an index for evaluating the bulk of the kitchen paper.

In the present embodiment, the kitchen paper KP is wound such that the thickness of a stack of five sheets of the kitchen paper KP falls within the above ranges to increase the bulk of the kitchen paper KP constituting the kitchen paper roll PR while making the kitchen paper KP less likely to be flattened in the thickness direction. Therefore, according to the kitchen paper roll PR of the present embodiment, the absorbency of the kitchen paper KP can be further improved.

The kitchen paper KP constituting the kitchen paper roll PR described above may be used as kitchen paper according to the present embodiment. Accordingly, the kitchen paper of the present embodiment has the same effects as those of the kitchen paper roll PR described above. That is, the present embodiment provides kitchen paper configured such that the absorbency and the softness of the kitchen paper can be maintained even when the winding length of the kitchen paper is increased.

The kitchen paper of the present embodiment is implemented by the kitchen paper KP constituting the kitchen paper roll PR described above, and the sheets 10 and 20 of the kitchen paper do not include a non-embossed region. This in turn makes it possible to maintain or improve the absorbency of the kitchen paper KP constituting the kitchen paper roll PR as well as to obtain softer kitchen paper.

### EXAMPLES

The present invention is described in more detail below by using examples. The measurement and evaluation of examples and comparative examples were performed as described below.

### [Basis Weight]

The basis weight (paper density, g/m²) of each sheet (crepe paper used as base paper) constituting the kitchen paper of the kitchen paper roll was calculated according to JIS P 8124 (1998).

### [Bulk]

The bulk (mm) of the kitchen paper constituting the kitchen paper roll was measured. In the method of measuring the bulk, specimens were prepared first by consecutively cutting off thirteenth through seventeenth sheets of the kitchen paper from the kitchen paper roll and by cutting the five sheets of the kitchen paper into strips with a size of 120 mm×120 mm. After sufficiently adjusting the humidity of the prepared specimens under the conditions defined in JIS P 8111 (1998), the thickness of the specimens was measured using a dial thickness gauge (thickness measuring instrument) “PEACOCK model G” (manufactured by OZAKI MFG. CO., LTD) under the same conditions. In an actual measurement procedure, after confirming that there is no dust or dirt between a plunger and a measurement table, the plunger is lowered onto the measurement table, and the scale of the dial thickness gauge is moved to adjust the zero point. The plunger is lifted to place a stack of five specimens on the measurement table, the plunger is slowly lowered, and then the gauge is read. In this process, the plunger is just placed on the specimens. The plunger has a circular end part that is made of a metal and has a diameter of 30 mm. The plunger is placed on the specimens such that a flat surface of the circular end part perpendicularly contacts the paper surface. The load applied to measure the bulk is about 70 gf at 120 μm. An average of ten measurements is used as the measurement of the bulk.

### [Oil Absorption Test]

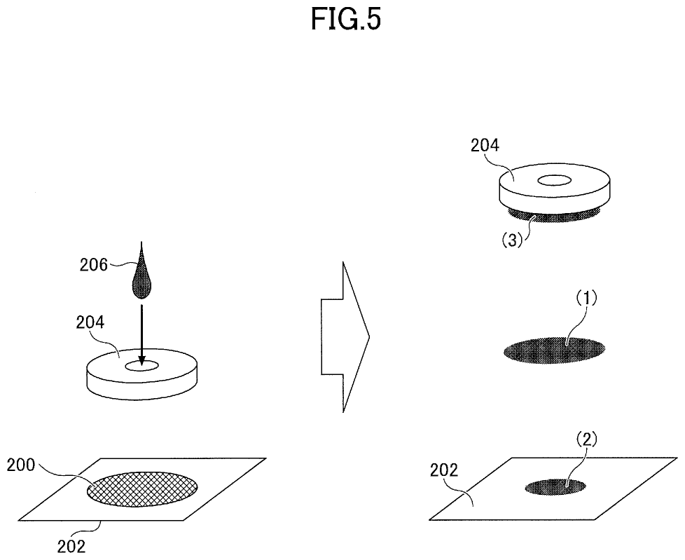

A specimen 200 is prepared by cutting the kitchen paper 100 into a shape with the same size (a diameter of about 82 mm) as a weight 204. Using an electronic balance (e.g., HR-300 manufactured by A&D Company Ltd.), weights of a plastic sheet 202 (size: about 12 cm×12 cm, thickness: 0.2 mm, weight: 2.7 g, material: polypropylene), the specimen 200, and the weight 204 (diameter: about 82 mm, thickness: 10 mm, weight: 59 g, material: acrylic) illustrated in FIG. 5 are measured. After the measurement, the specimen 200 is placed on the plastic sheet 202, and the weight 204 is placed on the center of the specimen 200. The weight 204 has a hole that passes through the weight 204 in the thickness direction. The diameter of the hole is about 12 mm. Then, 3.5 ml (about 3 g) of oil 206 (salad oil at normal temperature) (Nissin salad oil manufactured by The Nisshin OilliO Group, Ltd.) is dropped through the hole in the weight 204 by using a pipette (Finnpipette F2, 0.5 to 5 ml, manufactured by Thermo Fisher Scientific K.K.). In this step, the dropping position (embossed portion) is fixed at the center position of the specimen 200 as illustrated in FIG. 5. After two minutes from the dropping of the oil (after being kept in this state for 2 minutes), the weight 204 is removed and its weight is measured. Next, the plastic sheet 202 is removed and its weight is measured. Then, the weight of the specimen 200 is measured. For each specimen 200, as illustrated in FIG. 5, (1) a specimen oil absorption amount (g), (2) a bleed-through amount (g), (3) a return amount (g), a dropped oil amount (g), a specimen oil absorption percentage in the dropped oil amount (%), a bleed-through percentage (%), a return rate (%), and a time (oil absorption speed) (s) taken by the oil spot to spread out of the weight 204 were measured. The measurement results are provided in Table 1. Measurement items such as the specimen oil absorption amount (g) were calculated by using formulas below.

Specimen oil absorption amount (g)=specimen weight after two minutes from dropping of oil−specimen weight

Bleed-through amount (g)=plastic sheet weight after two minutes from dropping of oil−plastic sheet weight

Return amount (g)=weight of weight after two minutes from dropping of oil−weight of weight

Dropped oil amount (g)=specimen oil absorption amount+bleed-through amount+return amount

Specimen oil absorption percentage (%)=specimen oil absorption amount/dropped oil amount×100

Bleed-through percentage (%)=bleed-through amount/dropped oil amount×100

Return rate (%)=return amount/dropped oil amount×100

An average of three measurements is used for each of (1) specimen oil absorption amount (g), (2) bleed-through amount (g), (3) return amount (g), and dropped oil amount (g). From these measurements including the specimen oil absorption amount (g), the specimen oil absorption percentage (%), the bleed-through percentage (%), and the return rate (%) were calculated.

### [Softness]

Softness was measured based on a handle-o-meter method conforming to the JIS L 1096 E method. In the measurement, a specimen cut into a 100 mm×100 mm size was used, and the slit width (clearance) of the handle-o-meter was set at 20 mm. The softness of the specimen (two plies) was measured five times in each of the vertical and horizontal directions, and the softness was represented by the average value of the ten measurements with two decimal places in units of cN. A smaller softness value (cN) indicates that the specimen is softer. The softness was measured only in Example 1 and Comparative Example 2.

### Example 1

In Example 1, the kitchen paper KP (100) wound to form the kitchen paper roll PR illustrated in FIGS. 1 to 4 was used. The kitchen paper KP (100) was formed by an embossing method in which sheets 10 and 20 with a basis weight (paper density) of 18 g/m² were joined in a nested manner. The embossed protrusions EC1 and EC2 in the embossed regions 30 and 40 of the sheets 10 and 20 had a circular top shape (protrusion shape), a density (the number of protrusions) of 0.08/mm², a top size (protrusion size) of 1.35 mm, a top unit area (protrusion area) of 1.43 mm², an area percentage (glued area percentage) of 11.2%, and an area ratio (area proportion) of 0.53. The thickness difference (paper thickness difference) was set at 0.07 mm. The kitchen paper roll PR had a paper core outer diameter of 39 mm, a winding length of the kitchen paper KP (100) of 22 m, a winding diameter of 117 mm, a winding density of 0.23 m/cm², and a bulk of 2.4 mm/5 sheets. In Example 1, no line (non-embossed space) was formed in the kitchen paper KP (100). The measured softness was 9.89 cN. In Example 1, absorbency and softness were evaluated. Except for the softness, the evaluation results are provided in Table 1.

### Example 2

In Example 2, evaluation was performed substantially in the same manner as in Example 1, except that the paper density was set at 19.3 g/m² and the bulk was set at 2.5 mm/5 sheets. The results are provided in Table 1.

### Example 3

In Example 3, evaluation was performed substantially in the same manner as in Example 1, except that the paper density was set at 22.4 g/m², the thickness difference was set at 0.08 mm, and the bulk was set at 2.5 mm/5 sheets. The results are provided in Table 1.

### Example 4

In Example 4, evaluation was performed substantially in the same manner as in Example 1, except that the paper density was set at 21.2 g/m², the thickness difference was set at 0.1 mm, the winding length was set at 11 m, the winding diameter was set at 105 mm, the winding density was set at 0.15 m/cm², and the bulk was set at 3.3 mm/5 sheets. The results are provided in Table 1.

### Comparative Example 1

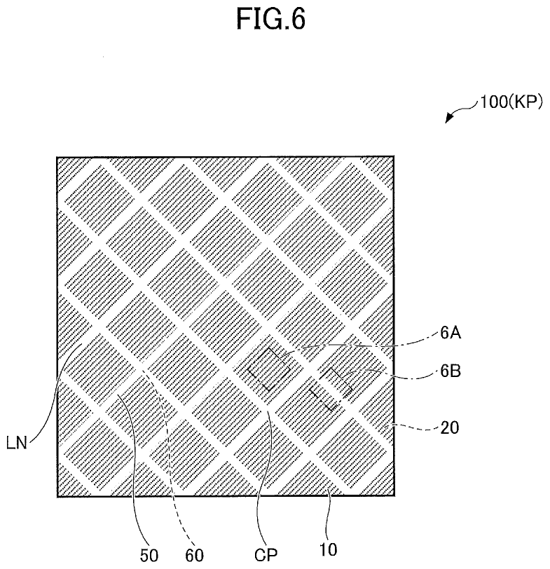

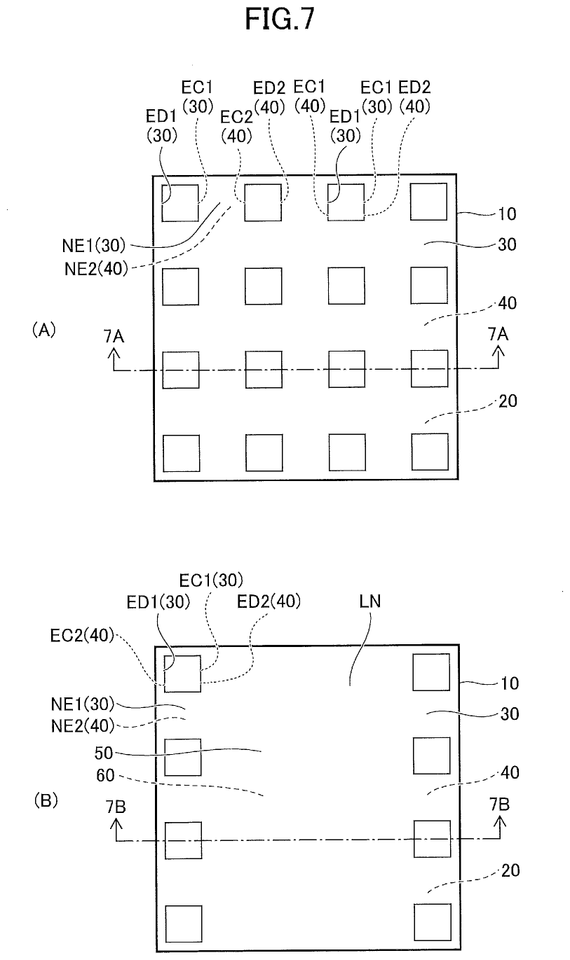

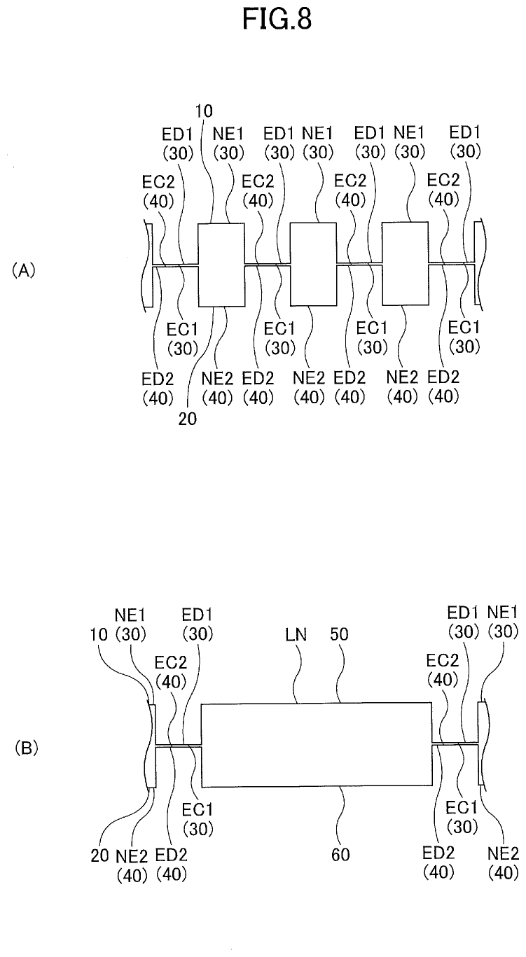

In Comparative Example 1, kitchen paper 100 (KR) illustrated in FIGS. 6 through 8 was used. The kitchen paper KP (100) was formed by an embossing method where sheets 10 and 20 with a paper density of 17.8 g/m² were joined in a tip-to-tip manner. Embossed protrusions EC1 and EC2 in embossed regions 30 and 40 of the sheets 10 and 20 had a rectangular top shape (protrusion shape), a density (the number of protrusions) of 0.09/mm², a top size (protrusion size) of 1.1 mm, a top unit area (protrusion area) of 1.21 mm², an area percentage (glued area percentage) of 11.3%, a non-embossed space area percentage (line area percentage) of 37.4%, and an area ratio (area proportion) of 0.38. The thickness difference (paper thickness difference) was set at 0.02 mm. The kitchen paper roll PR had a paper core outer diameter of 39 mm, a winding length of the kitchen paper KP (100) of 22 m, a winding diameter of 110 mm, a winding density of 0.26 m/cm², and a bulk of 2.1 mm/5 sheets. In Comparative Example 1, non-embossed regions 50 and 60 are formed on the sheets 10 and 20, and a grid-shaped line LN (non-embossed space), where the non-embossed regions 50 and 60 face each other, is formed in the kitchen paper KP (100). In Comparative Example 1, evaluation was performed in substantially the same manner as in Example 1. The results are provided in Table 1.

### Comparative Example 2

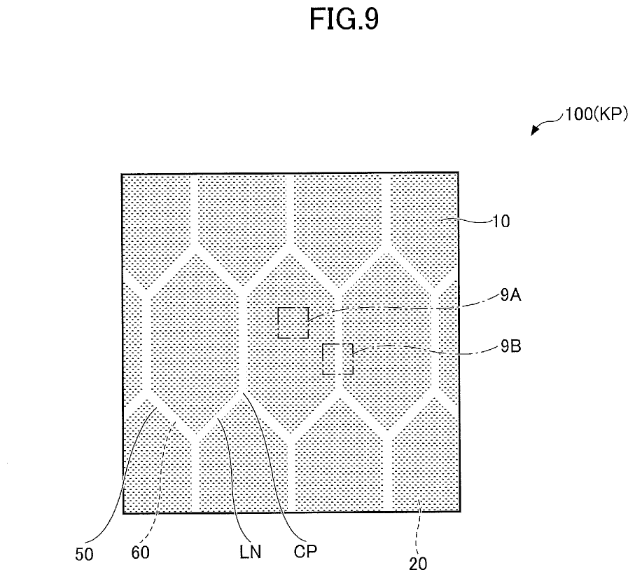

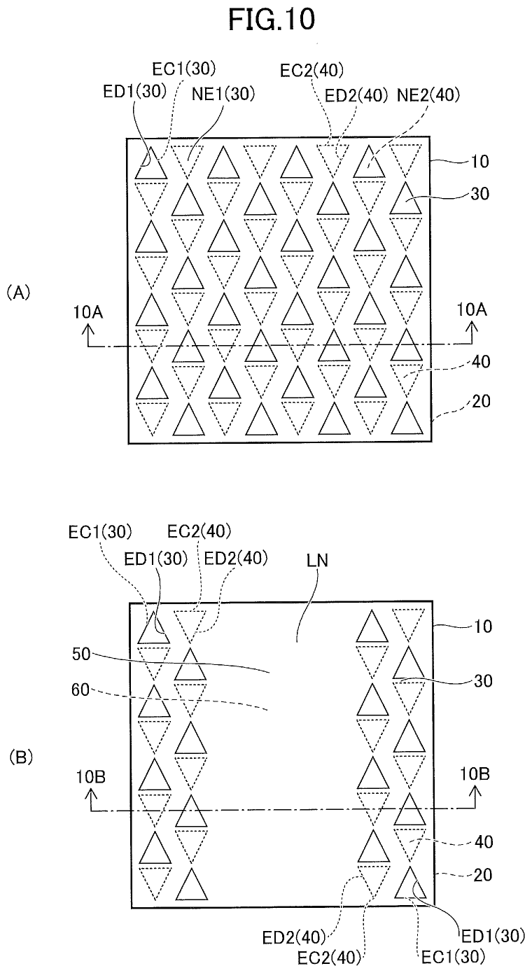

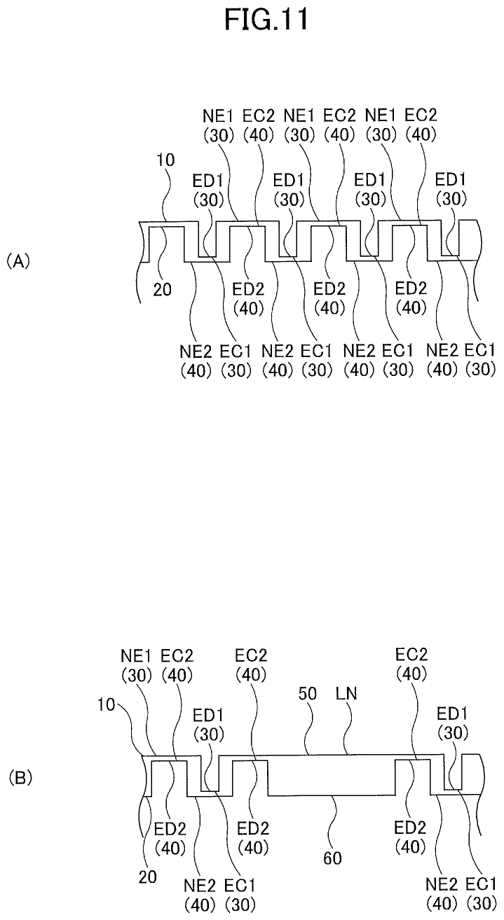

In Comparative Example 2, kitchen paper 100 (KR) illustrated in FIGS. 9 through 11 was used. The kitchen paper KP (100) was formed by an embossing method where sheets 10 and 20 with a paper density of 22.8 g/m² were joined in a nested manner. Embossed protrusions EC1 and EC2 in embossed regions 30 and 40 of the sheets 10 and 20 had a triangular top shape (protrusion shape), a density (the number of protrusions) of 0.05/mm², a top size (protrusion size) of 1.4 mm, a top unit area (protrusion area) of 1.7 mm², an area percentage (glued area percentage) of 8.1%, a non-embossed space area percentage (line area percentage) of 19.1%, and an area ratio (area proportion) of 0.5. The thickness difference (paper thickness difference) was set at 0.12 mm. The kitchen paper roll PR had a paper core outer diameter of 39 mm, a winding length of the kitchen paper KP (100) of 22 m, a winding diameter of 114 mm, a winding density of 0.24 m/cm², and a bulk of 2.5 mm/5 sheets. In Comparative Example 2, non-embossed regions 50 and 60 are formed on the sheets 10 and 20, and a honeycomb-shaped line LN (non-embossed space), where the non-embossed regions 50 and 60 face each other, is formed in the kitchen paper KP (100). The measured softness was 14.50 cN. In Comparative Example 2, evaluation was performed in substantially the same manner as in Example 1. The results are provided in Table 1.

### Comparative Example 3

In Comparative Example 3, unshown kitchen paper was used. The kitchen paper was formed by an embossing method where two sheets with a paper density of 21 g/m² were joined in a nested manner. Embossed protrusions in embossed regions of the sheets had an oblong top shape (protrusion shape), a density (the number of protrusions) of 0.08/mm², a top size (protrusion size): a long diameter of 1.5 mm and a short diameter of 0.75 mm, a top unit area (protrusion area) of 0.88 mm², an area percentage (glued area percentage) of 7.5%, a non-embossed space area percentage (line area percentage) of 25.1%, and an area ratio (area proportion) of 0.28. The thickness difference (paper thickness difference) was set at 0.04 mm. The kitchen paper roll PR had a paper core outer diameter of 39 mm, a winding length of the kitchen paper of 35.9 m, a winding diameter of 118 mm, a winding density of 0.37 m/cm², and a bulk of 1.8 mm/5 sheets. In Comparative Example 3, non-embossed regions are formed on the sheets, and a curved line (non-embossed space) (not shown), where the non-embossed regions face each other, is formed in the kitchen paper. In Comparative Example 3, evaluation was performed in substantially the same manner as in Example 1. The results are provided in Table 1.

### Comparative Example 4

In Comparative Example 4, unshown kitchen paper was used. The kitchen paper was formed by an embossing method where two sheets with a paper density of 21.2 g/m² were joined in a nested manner. Embossed protrusions in embossed regions of the sheets had a circular top shape (protrusion shape), a density (the number of protrusions) of 0.07/mm², a top size (protrusion size) of 1.5 mm, a top unit area (protrusion area) of 1.77 mm², an area percentage (glued area percentage) of 11.7%, and an area ratio (area proportion) of 0.65. The thickness difference (paper thickness difference) was set at 0.02 mm. The kitchen paper roll PR had a paper core outer diameter of 39 mm, a winding length of the kitchen paper of 22 m, a winding diameter of 105 mm, a winding density of 0.29 m/cm², and a bulk of 1.8 mm/5 sheets. In Comparative Example 4, no line (non-embossed space) was formed in the kitchen paper. In Comparative Example 4, evaluation was performed in substantially the same manner as in Example 1. The results are provided in Table 1.

TABLE 1

| | | | | | | Compara- | Compara- | Compara- | Compara- |
|---|---|---|---|---|---|---|---|---|---|
| | | Example 1 | Example 2 | Example3 | Example 4 | tive 1 | tive 2 | tive 3 | tive 4 |
| Embossing method | | Nested | Nested | Nested | Nested | Tip-to-tip | Nested | Nested | Nested |
| Protrusion shape | | Circular | Circular | Circular | Circular | Rectangular | Triangular | Oblong | Circular |
| Number of protrusions | /mm² | 0.08 | 0.08 | 0.08 | 0.08 | 0.09 | 0.05 | 0.08 | 0.07 |
| Protrusion size | mm | 1.35 | 1.35 | 1.35 | 1.35 | 1.1 | 1.4 | 1.5, 0.75 | 1.5 |
| Protrusion area | mm² | 1.43 | 1.43 | 1.43 | 1.43 | 1.21 | 1.7 | 0.88 | 1.77 |
| Area percentage (glued area | % | 11.2 | 11.2 | 11.2 | 11.2 | 11.3 | 8.1 | 7.5 | 11.7 |
| percentage) | | | | | | | | | |
| Line area percentage | % | — | — | — | — | 37.4 | 19.1 | 25.1 | — |
| Paper density | g/m² | 18 | 19.3 | 22.4 | 21.2 | 17.8 | 22.8 | 21 | 21.2 |
| Winding length | m | 22 | 22 | 22 | 11 | 22 | 22 | 35.9 | 22 |
| Winding diameter | mm | 117 | 117 | 117 | 105 | 110 | 114 | 118 | 105 |
| Paper core outer diameter | mm | 39 | 39 | 39 | 39 | 39 | 39 | 39 | 39 |
| Winding density | m/cm² | 0.23 | 0.23 | 0.23 | 0.15 | 0.26 | 0.24 | 0.37 | 0.29 |
| Bulk | mm/5 sh | 2.4 | 2.5 | 2.5 | 3.3 | 2.1 | 2.5 | 1.8 | 1.8 |
| Dropped oil amount | g | 2.9 | 3 | 3.1 | 3.1 | 3.1 | 3 | 3.1 | 3.2 |
| Absorption percentage | % | 73 | 73.5 | 73.7 | 78.1 | 61.7 | 68.7 | 53.3 | 49.8 |
| Return rate | % | 13 | 12.5 | 11.9 | 10.1 | 14 | 14.6 | 12.2 | 11.6 |
| Bleed-through percentage | % | 14 | 14 | 14.4 | 11.7 | 24.3 | 16.7 | 34.5 | 38.6 |
| Protrusion area/cm² (min) | mm² | 0.14 | 0.14 | 0.14 | 0.14 | 0.07 | 0.14 | 0.04 | 0.19 |
| Protrusion area/cm² (max) | mm² | 0.26 | 0.26 | 0.26 | 0.26 | 0.19 | 0.27 | 0.16 | 0.3 |
| Area ratio | | 0.53 | 0.53 | 0.53 | 0.53 | 0.38 | 0.5 | 0.28 | 0.65 |
| Thickness/sheet (min) | mm | 0.2 | 0.22 | 0.23 | 0.27 | 0.15 | 0.19 | 0.17 | 0.2 |
| Thickness/sheet (max) | mm | 0.27 | 0.29 | 0.31 | 0.37 | 0.17 | 0.31 | 0.21 | 0.22 |
| Thickness difference | mm | 0.07 | 0.07 | 0.08 | 0.1 | 0.02 | 0.12 | 0.04 | 0.02 |

As indicated in Table 1, when the kitchen paper roll PR is formed by winding the kitchen paper KP formed by joining two sheets 10 and 20 in a nested manner, the density of the embossed protrusions on each sheet is greater than or equal to 0.075/mm² and less than or equal to 0.2/mm², the winding density of the kitchen paper KP is greater than or equal to 0.12 m/cm² and less than or equal to 0.27 m/cm², and the ratio of the minimum embossment area to the maximum embossment area in the kitchen paper KP is greater than or equal to 0.51, the oil absorption percentage is greater than or equal to 70%, the return rate is less than 14%, and the bleed-through percentage is less than 16% (Examples 1 through 4).

On the other hand, when a kitchen paper roll does not satisfy any of the conditions including: the kitchen paper roll is formed by winding kitchen paper that is formed by joining two sheets in a nested manner, the density of embossed protrusions on each sheet is greater than or equal to 0.075/mm² and less than or equal to 0.2/mm², the winding density of the kitchen paper is greater than or equal to 0.12 m/cm² and less than or equal to 0.27 m/cm², and the ratio of the minimum embossment area to the maximum embossment area in the kitchen paper KP is greater than or equal to 0.51, the oil absorption rate is less than 70%, and the bleed-through percentage is greater than or equal to 16% (Comparative Examples 1 through 4). Also, in Comparative Example 1 and Comparative Example 2, the return rate is greater than or equal to 14%.

Also, while the measurement of softness in Comparative Example 2 is 14.50 cN, the measurement of softness in Example 1 is 9.89 cN. Thus, the kitchen paper KP is softer in Example 1 than in Comparative Example 2.

These results indicate that when a kitchen paper roll is formed by winding kitchen paper formed by joining two sheets including embossed regions in a nested manner, the density of embossed protrusions on each sheet is greater than or equal to 0.075/mm² and less than or equal to 0.2/mm², the winding density of the kitchen paper is greater than or equal to 0.12 m/cm² and less than or equal to 0.27 m/cm², and the ratio of the minimum embossment area to the maximum embossment area in the kitchen paper KP is greater than or equal to 0.51, the absorbency and the softness of the kitchen paper are maintained even if the winding length of the kitchen paper is increased.

Preferred embodiments of the present invention are described above. However, the present invention is not limited to the specifically disclosed embodiments, and variations and modifications may be made without departing from the scope of the present invention described in the claims.

Preferred Embodiments of the Present Invention are described below as appendices.

A first embodiment of the present invention provides a kitchen paper roll formed by winding kitchen paper that is formed by joining two sheets including embossed regions in a nested manner. In the kitchen paper roll, the density of embossed protrusions on each of the sheets is greater than or equal to 0.075/mm² and less than or equal to 0.2/mm², the winding density of the kitchen paper is greater than or equal to 0.12 m/cm² and less than or equal to 0.27 m/cm², and the ratio of a minimum embossment area to a maximum embossment area in the kitchen paper is greater than or equal to 0.51.

In the present application, an embossed region indicates a region in a sheet on which an embossing process is performed (i.e., a region including only embossed protrusions and non-embossed protrusions surrounded by the embossed protrusions). The density of embossed protrusions indicates the number (count) of embossed protrusions per unit area (mm²) of a sheet. The winding density is a value obtained by dividing the winding length (m) of the kitchen paper by an area (cm²) in the radial direction of the kitchen paper roll.

Also, in the present application, the minimum embossment area is the area of a portion of the kitchen paper where the total area of the top parts of embossed protrusions per unit area is smallest. The maximum embossment area indicates the area of a portion of the kitchen paper where the total area of the top parts of embossed protrusions per unit area is largest. The ratio of the minimum embossment area to the maximum embossment area indicates the area ratio of the minimum embossment area to the maximum embossment area.

In the first embodiment, the kitchen paper constituting the kitchen paper roll is formed by joining two sheets in a nested manner. The kitchen paper is wound such that the winding density becomes greater than or equal to 0.12 m/cm² and less than or equal to 0.27 m/cm². Also, in the kitchen paper, the area ratio of the minimum embossment area to the maximum embossment area is greater than or equal to 0.51.

The kitchen paper wound to form the kitchen paper roll as described above is less likely to be flattened in the thickness direction, and the space inside of the kitchen paper can be maintained. Thus, in the first embodiment, the kitchen paper is less likely to be flattened in the thickness direction even when the winding density of the kitchen paper is high. The first embodiment also makes it possible to increase the winding length of the kitchen paper while maintaining the bulk of the kitchen paper.

Accordingly, according to the first embodiment, the absorbency of the kitchen paper can be maintained even when the winding length of the kitchen paper is increased. Also, the softness of the kitchen paper can be maintained even when the winding length of the kitchen paper is increased.

A second embodiment of the present invention provides a kitchen paper roll in which each of the sheets includes only the embossed region. That is, in the kitchen paper roll of the second embodiment, each sheet does not include a non-embossed region. In the present application, the non-embossed region indicates a region in a sheet on which the embossing process is not performed (i.e., a region where embossed protrusions and non-embossed protrusions are not formed).

In the second embodiment, because the sheets constituting kitchen paper do not include non-embossed regions, a non-embossed space (hereafter, non-embossed space) where the non-embossed regions face each other is not formed in the kitchen paper.

The non-embossed space is sometimes provided to increase the absorbency of kitchen paper because the non-embossed space makes it possible to retain water and oil absorbed by the kitchen paper and disperse water and oil in the kitchen paper. However, when such a non-embossed space exists in kitchen paper constituting a kitchen paper roll, the kitchen paper wound into the kitchen paper roll is more likely to be flattened, and the absorbency of the kitchen paper is decreased rather than being increased. On the other hand, in the second embodiment, because such a non-embossed space does not exist in the kitchen paper, the absorbency of the kitchen paper can be maintained even in the state of the kitchen paper roll.

Also, if a non-embossed space exists in the kitchen paper, the kitchen paper tends to become hard. As a result, it becomes difficult to fold the kitchen paper and to wipe curved surfaces and gaps with the kitchen paper. On the other hand, in the second embodiment, because such a non-embossed space does not exist in the kitchen paper, the kitchen paper constituting the kitchen paper roll becomes soft and easily foldable, and it becomes easier to wipe curved surfaces and gaps with the kitchen paper.

Also, as described above, configuring kitchen paper constituting a kitchen paper roll such that the ratio of the minimum embossment area to the maximum embossment area becomes greater than or equal to 0.51 makes it possible to obtain a kitchen paper roll constituted by kitchen paper that does not include a non-embossed space. Also, this configuration makes it possible to maintain the absorbency of kitchen paper and obtain soft kitchen paper without forming a non-embossed region in each of sheets constituting the kitchen paper.

A third embodiment of the present invention provides a kitchen paper roll in which the area percentage of embossed protrusions in the embossed region in each of the sheets is greater than or equal to 8% and less than or equal to 14%. In the present application, the area percentage of embossed protrusions indicates a percentage of the area of the top parts of embossed protrusions in the embossed region in the surface of each sheet. When the area percentage of embossed protrusions is greater than or equal to 8% and less than or equal to 14%, a sufficient space is formed in the kitchen paper, and the space is not readily flattened. Accordingly, the third embodiment makes it possible to increase the absorbency of the kitchen paper and to obtain softer kitchen paper.

A fourth embodiment of the present invention provides a kitchen paper roll formed of kitchen paper in which the difference between the maximum thickness and the minimum thickness is greater than or equal to 0.03 mm and less than or equal to 0.115 mm. The maximum thickness is the thickness of a portion of the kitchen paper having the largest thickness. The minimum thickness is the thickness of a portion of the kitchen paper having the smallest thickness. The difference (hereafter, thickness difference) between the maximum thickness and the minimum thickness is obtained by subtracting the minimum thickness from the maximum thickness.

In the fourth embodiment, the difference (which is hereafter referred to as a thickness difference) between the maximum thickness and the minimum thickness of the kitchen paper constituting the kitchen paper roll is set at a value greater than or equal to 0.03 mm and less than or equal to 0.115 mm. This makes the kitchen paper less likely to be flattened in the thickness direction and makes it possible to increase the bulk of the kitchen paper. Thus, the fourth embodiment makes it possible to further increase the absorbency of the kitchen paper and to obtain softer kitchen paper.

A fifth embodiment of the present invention provides a kitchen paper roll configured such that a stack of five sheets of the kitchen paper has a thickness greater than or equal to 1.9 mm and less than or equal to 4 mm. The thickness of the stack of five sheets of the kitchen paper is the thickness (mm) in the stacking direction of five sheets of the kitchen paper obtained from the kitchen paper roll.

In the fifth embodiment, the kitchen paper is wound such that the thickness of a stack of five sheets of the kitchen paper becomes greater than or equal to 1.9 mm and less than or equal to 4 mm. This makes the kitchen paper constituting the kitchen paper roll less likely to be flattened in the thickness direction and makes it possible to increase the bulk of the kitchen paper. Accordingly, the fifth embodiment makes it possible to improve the absorbency of kitchen paper and to obtain softer kitchen paper.

A sixth embodiment of the present invention provides kitchen paper that is formed by joining two sheets including embossed regions in a nested manner and to be wound to form a kitchen paper roll. The winding density of the kitchen paper in the kitchen paper roll is greater than or equal to 0.12 m/cm² and less than or equal to 0.27 m/cm², and the ratio of a minimum embossment area to a maximum embossment area in each of the sheets is greater than or equal to 0.51.

The sixth embodiment provides kitchen paper that can form the kitchen paper roll of the first embodiment described above and therefore can achieve effects that are the same as those of the kitchen paper roll of the first embodiment. That is, the sixth embodiment makes it possible to maintain the absorbency of the kitchen paper even when the winding length of the kitchen paper is increased and makes it possible to obtain a softer kitchen paper.

A seventh embodiment of the present invention provides kitchen paper formed of sheets each of which includes only an embossed region. The seventh embodiment provides kitchen paper that can form the kitchen paper roll of the second embodiment described above and therefore can achieve effects that are the same as those of the kitchen paper roll of the second embodiment. That is, according to the seventh embodiment, each of the sheets constituting the kitchen paper does not include a non-embossed region. This makes it possible to improve the absorbency of kitchen paper constituting the kitchen paper roll and to obtain softer kitchen paper.

The present international application claims priority to Japanese Patent Application No. 2018-107295 filed on Jun. 4, 2018, the entire contents of which are hereby incorporated herein by reference.

### EXPLANATION OF REFERENCE NUMERALS

PR kitchen paper roll
KP kitchen paper
10 sheet
20 sheet
30 embossed region
EC1 embossed protrusion
ED1 embossed recess
NE1 non-embossed protrusion
40 embossed region
EC2 embossed protrusion
ED2 embossed recess
NE2 non-embossed protrusion
CC cylindrical core

1. A kitchen paper roll, comprising:
a kitchen paper that is formed by joining two sheets in a nested manner and is wound to form the kitchen paper roll, each of the sheets including an embossed region, wherein
a density of embossed protrusions on each of the sheets is greater than or equal to 0.075/mm² and less than or equal to 0.2/mm²;
a winding density of the kitchen paper is greater than or equal to 0.12 m/cm² and less than or equal to 0.27 m/cm²; and
a ratio of a minimum embossment area to a maximum embossment area in the kitchen paper is greater than or equal to 0.51.

2. The kitchen paper roll as claimed in claim 1, wherein each of the sheets includes only the embossed region.

3. The kitchen paper roll as claimed in claim 1, wherein an area percentage of the embossed protrusions in the embossed region of each of the sheets is greater than or equal to 8% and less than or equal to 14%.

4. The kitchen paper roll as claimed in claim 1, wherein a difference between a maximum thickness and a minimum thickness of the kitchen paper is greater than or equal to 0.03 mm and less than or equal to 0.115 mm.

5. The kitchen paper roll as claimed in claim 1, wherein a thickness of a stack of five sheets of the kitchen paper is greater than or equal to 1.9 mm and less than or equal to 4 mm.

6. A kitchen paper to be wound to form a kitchen paper roll, the kitchen paper comprising:
two sheets that are joined in a nested manner, each of the sheets including an embossed region, wherein
a winding density of the kitchen paper wound into the kitchen paper roll is greater than or equal to 0.12 m/cm² and less than or equal to 0.27 m/cm²; and
a ratio of a minimum embossment area to a maximum embossment area in each of the sheets is greater than or equal to 0.51.

7. The kitchen paper as claimed in claim 6, wherein each of the sheets includes only the embossed region.
